(19) United States
(12) Patent Application Publication
(10) Pub. No.: US 2011/0042532 A1
(43) Pub. Date: Feb. 24, 2011

(54) PAD HANGER

(75) Inventors: James E. NASH, Bloomington, MN (US); Lee A. Fain, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/858,941

(22) Filed: Aug. 18, 2010

Related U.S. Application Data
(60) Provisional application No. 61/234,766, filed on Aug. 18, 2009.
(60) Provisional application No. 61/235,513, filed on Aug. 20, 2009.

(51) Int. Cl. F16M 13/02

(52) U.S. Cl. 248/205.1

(57) ABSTRACT

An easel pad hanger comprising: an elongated back plate having a front major surface and a rear major surface; and at least one pad support projecting from the front major surface of the back plate wherein the pad support comprises a shelf portion, a stop portion projecting from the distal end of the shelf portion, and preferably a ramp portion projecting from the distal end of the stop portion. The back plate is preferably adapted to be mounted to a support, e.g., a wall or easel stand, and is optionally adapted, e.g., with one or more shelves, openings, slots, etc. to store peripheral tools, e.g., note pads, writing instruments, calculators, etc.

### CROSS REFERENCE TO RELATED APPLICATION

This application claims the benefit of U.S. Provisional Patent Application Nos. 61/234766, filed Aug. 18, 2009 and 61/235513, filed Aug. 20, 2009, the disclosure of which is incorporated by reference herein in its entirety.

### FIELD

The present invention relates to pad hangers, e.g., such as for easel pads.

### BACKGROUND

Holders for large paper pads used in meetings, lectures, presentations, and other displays are well known. Such holders generally comprise a back support member having two or more spaced pins or pegs wherein the support member is adapted to be mounted to an upright support or stand, e.g., an easel, and the pins or pegs are adapted to permit hanging a pad with complementary holes or slots thereon.

In some embodiments, the holder comprises a clamping member which overlies the pins in a clamped position so as to hold the pad in place and opens to uncover the pins so as to permit removal and replacement of the pad. Illustrative embodiments of such holders are disclosed in U.S. Pat. No. 3,947,138 (Eshelman) and U.S. Pat. No. 4,623,169 (Hutten). U.S. Patent Appln. Publn. No. 2006/0021269 (Doctoroff) discloses a hanger for display sheets wherein the pins have pivotable clamps at the end thereof to secure the pad or stack of sheets thereto. The intricacies in operating the clamps on such pins call for precision and coordination when loading and unloading easel pads.

A need exists for pad hangers which are more simply and conveniently used to beneficial effect.

### SUMMARY

The present invention provides a hanger for paper pads, e.g., sometimes referred to as easel pads.

In brief summary, hangers of the invention comprise an elongated back member having a front major surface and a rear major surface; and at least one pad support as described herein projecting from the front major surface. The back member is preferably adapted to be engaged with a support. The pad supports comprises a shelf portion, a stop portion, and preferably a ramp portion. In some embodiments, hangers of the invention may be adapted to secure peripheral tools such as writing implements, note sheets, calculators, etc.

Hangers of the invention can possess a simple design making them easy and low cost to manufacture, small enough to be readily portable, and easy to use.

### BRIEF DESCRIPTION OF DRAWING

The invention is further explained with reference to the drawing wherein:

FIG. 1 is a perspective view of one embodiment of a hanger of the invention;

FIG. 2 is a plan view of the hanger shown in FIG. 1; and

FIG. 3 is a cross sectional view of a portion of the hanger shown in FIG. 1.

These figures are not to scale and are intended to be merely illustrative and not limiting.

### DETAILED DESCRIPTION OF ILLUSTRATIVE EMBODIMENTS

Orientation terms such as “lower”, “upper”, etc. which are used in the following description are used in reference to the typical installed position of the hanger, e.g., on a wall or other vertical support.

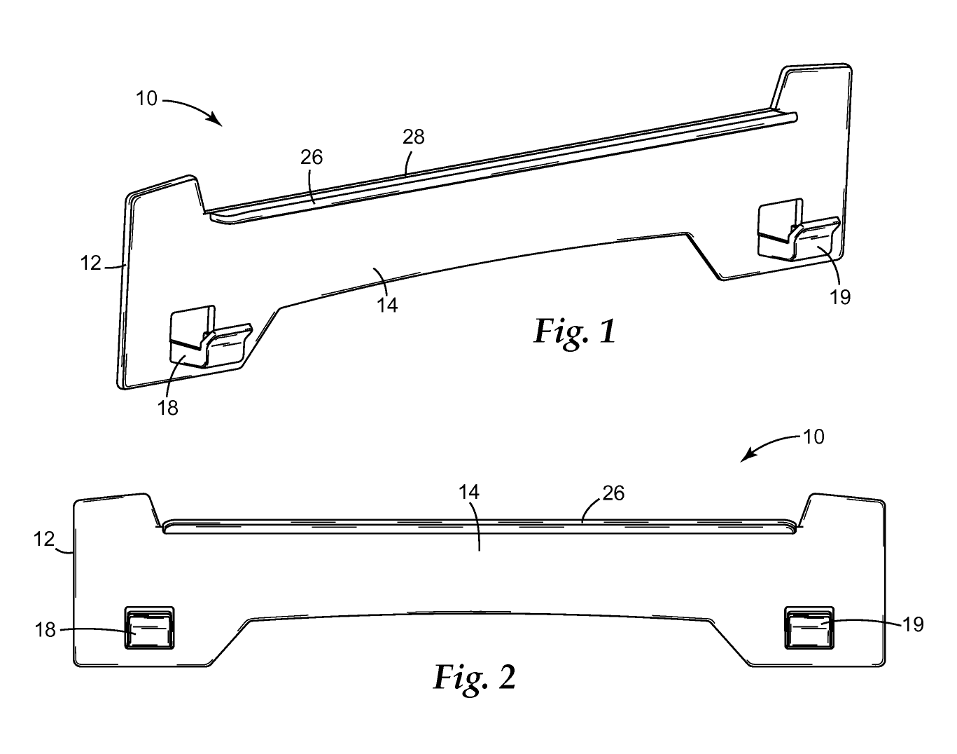

An illustrative embodiment of a hanger of the invention is shown in FIGS. 1-3 wherein is shown hanger 10 which comprises: an elongated back member 12 having a front major surface 14 and a rear major surface 16; and two pad supports 18, 19 projecting from the front major surface 14 wherein pad supports 18, 19 each comprise a shelf portion 20, a stop portion 22, and a ramp portion 24.

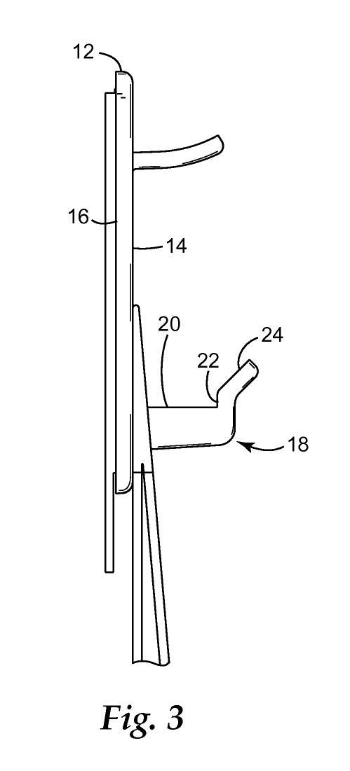

The back member is preferably adapted to be engaged with a support, e.g., a wall, easel stand, or other generally vertical support. Those skilled in the art can readily choose appropriate adaptations. Illustrative examples include providing it with openings (not shown) such as screw holes or key holes, clips, tabs, adhesive mounting strips, etc. to permit securing the back member to a support. Other illustrative examples include securing the back member to a support with adhesive, gripping it with a support-mounted clamping mechanism, and standing the back member on shelf-like members of a support. In some embodiments the back member is substantially planar, e.g., as shown in FIGS. 1 and 3; in other embodiments it may be contoured as desired.

In instances where the pad hanger is to be mounted on a support such as a wall using 3M™ Command™ Mounting Strips it is typically preferred that the pad supports project from the front major surface at a position which is as low as or even below the corresponding position of the adhesive strips on the rear major surface of the back member. If the pad supports are located at positions higher than the attachment point of the mounting strip the hanger may tend to lean forward or pull from the vertical surface undesirably.

In accordance with the present invention, the hanger comprises at least one pad support that comprises, a shelf portion projecting outward from the back member, a stop portion projecting upward from the distal end of the shelf portion, and preferably a ramp portion projecting from the top or distal end of the stop portion.

In some embodiments, the hanger will comprise only one pad support. The support should be sufficiently wide (i.e., its dimension in the axis parallel to the longitudinal axis of the hanger) to provide stable support to the pad or pads adapted to be supported thereon (e.g., having a slot positioned substantially centrally so as to hang stably therefrom).

Typically it is preferred that the hanger comprise two or more pad supports. The pad supports are typically positioned on the hanger so as to be of substantially equal height or level when the hanger is installed. The pad supports are spaced apart in a manner and of a profile to conform to opening(s) in the easel pads to be hung thereon, e.g., from about 250 to about 560 mm (about 10 to about 22 inches) would accommodate many commonly used pads. In some embodiments, hangers of the invention may be made with more than two pad supports provided that the pads used therewith have openings corresponding thereto.

The shelf portion should be at least long enough, i.e., project outwardly from the front surface of the hanger far enough, to accommodate at least one pad, and if desired large enough to accommodate two or more pad so that the extra pads may be stored on the hanger. Storing extra pads on hangers of the invention can facilitate maintaining a neat and organized space as well as protects unused pads from damage which is common when they are stored on the floor. For instance, conventional easel pads are typically on the order of about 7 mm (about 0.25 inch) thick, thus the shelf portion of a hanger intended to support two pads will typically be about 13 mm (about 0.5 inch) or more long (i.e., the dimension from where it projects from the front major surface of the hanger to the point where the stop portion projects from the shelf portion). Hangers of the invention may have shelf portion(s) of any desired length, though as will be understood, the means by which the hanger is to be mounted on a vertical support should be sufficiently strong to support the hanger, number of pads likely to be hung thereon, and any peripheral tools. The width of the shelf portion, i.e., its dimension in the direction perpendicular to its length and parallel to the longitudinal axis of the hanger, may be of any suitable dimension. In many instances, a shelf portion width of from about 5 to about 25 mm is suitable. If pads which are more easily torn or warped are used, pad supports having widths of relatively greater dimension may be desired to minimize damage to the pad.

In some embodiments, the upper surface of the shelf portion will be in a substantially horizontal orientation, i.e., project outwardly from the back member substantially perpendicular thereto. In other embodiments it may be canted to desired degree. For instance, if canted so as to rise slightly at increasing distance from the back member, pad(s) which are held on the pad support will tend to rest more consistently securely against the vertical support, e.g., a wall. In order to reduce the tendency of

A stop portion 22 projects from the distal end of the shelf portion 20. The stop portion functions to retain a pad securely on the hanger, e.g., when a sheet is being removed from the pad, and extends in a generally upright direction, e.g., substantially vertically from the orientation of the shelf portion such as perpendicular to a shelf portion that is horizontal. The stop portion is typically preferably between about 3 and about 7 mm (about 0.125 and about 0.25 inch) high; though as will be understood, sizes outside this range may be used if desired. If the stop portion is too small, the hanger may not hold the pad as securely has desired. If the stop portion is unduly large, it may be difficult to put pads on the hanger and/or remove them.

Preferably the support 18 further comprises a ramp portion 24 projecting from the distal end of the stop portion 22. In many embodiments, the ramp portion is between about 7 mm to about 25 mm (about 0.125 inch to about 1) in length and extends at upwardly from the distal stop portion at a moderate angle, e.g., about 45° or so from vertical in the case of a substantially vertical stop portion, i.e., at an incline.

Turning to the embodiment shown in FIG. 3, typically shelf portion 20 is substantially perpendicular to the plane of the back member, and stop portion 22 is preferably substantially perpendicular to shelf portion 20. Also shown in FIG. 3, mounted on support 18 is pad 28 comprising binder 30 and sheets 32. On rear major surface 12 is a 3M™ Command™ Mounting Strip 34.

In the embodiment shown in FIGS. 1 to 3, hanger 10 further comprises a storage ledge 26 protruding from front major surface 14 at the upper edge of back member 12. The ledge may protrude from the upper edge of the front major surface as shown or may protrude from a lower location on the front major surface. Typically it will be preferred that the ledge have an outer edge that is raised above interior portions thereof so as to provide secure storage of such tools as writing instruments, straight edges, rulers, etc.

The pad hanger may be adapted in a variety of ways to provide ways to secure peripheral tools such as writing implements, note pads, calculators, erasers, etc.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. A number of patents and patent applications are cited herein to facilitate description of the present invention; each is incorporated herein by reference in its entirety.

What is claimed is:

1. A pad hanger comprising:
an elongated back member having a front major surface and a rear major surface; and
at least one pad support projecting from said front major surface of said back member wherein said pad support comprises a shelf portion projecting from said front major surface and a stop portion projecting from the distal end of said shelf portion.

2. The pad hanger of claim 1 further comprising a shelf protruding from said front major surface.

3. The pad hanger of claim 2 wherein said shelf protrudes from the upper edge of said back member.

4. The pad hanger of claim 1 wherein said shelf portion is substantially perpendicular to said back member.

5. The pad hanger of claim 1 wherein said shelf portion is from about 7 to about 25 mm long.

6. The pad hanger of claim 1 wherein said stop portion is substantially perpendicular to said shelf portion.

7. The pad hanger of claim 1 wherein said stop portion is from about 3 to about 7 mm long.

8. The pad hanger of claim 1 wherein said pad support comprises a ramp portion projecting from the distal end of said stop portion.

9. The pad hanger of claim 1 comprising two said pad supports spaced from about 250 to about 560 mm apart.

10. The pad hanger of claim 1 comprising at least one pad support comprising a shelf portion that is substantially perpendicular to the back member and having a length of from about 7 to about 25 mm, a stop portion that is perpendicular to said shelf portion and having a length of from about 3 to about 7 mm long, and a ramp portion projecting from said stop portion at an incline.
